(19) United States
(12) Patent Application Publication
(10) Pub. No.: US 2009/0072535 A1
(43) Pub. Date: Mar. 19, 2009

(54) COUPLING SYSTEM

(76) Inventors: Andreas Baumann, Nurtingen (DE); Uwe Paulini, Stuttgart (DE); Frank Reiners, Waiblingen (DE); Jurgen Stehlig, Neckartenzlingen (DE); Manfred Krauss, Hettstadt (DE); Soren Schroter, Bamberg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/994,073

(22) PCT Filed: May 26, 2006
(86) PCT No.: PCT/DE2006/000900

§ 371 Date: Jun. 17, 2008

(30) Foreign Application Priority Data
Jun. 28, 2005 (DE) 10 2005 030 457.5

(51) Int. Cl. F16L 37/20

(52) U.S. Cl. 285/311

(57) ABSTRACT

The invention relates to a coupling system (12) which is used to connect a tube (7) to a socket (8). Said tube (7) comprises a support (13) which is arranged on at least one or the ends thereof. Said support can be inserted into the socket (8) and the comprises, on the external side thereof, at least one annular groove (14) and a securing contour (16). The socket (8) comprises a stop contour (20) on the external side thereof. A coupling element (17), which is produced separately in relation to the socket (8) and the support (13), is placed on the outside on the support (13). The coupling element (17) comprises at least one stop hook (19) which engages behind the stop contour (20) when the support (13) is inserted into the socket (8). The coupling element (17) comprises at least one securing hook (18) which co-operates with the securing contour (16) in order to fix the coupling element (17) to the support (13) in an axial manner.

The present invention relates to a coupling system for connecting a tube of vent mechanism for removing blow-by gases from an internal combustion engine with a socket. The invention also relates to a coupling element and a tube with a connection for such a coupling system. Furthermore, the invention relates to an internal combustion engine in which a tube of a vent mechanism is connected to a fresh air system of the internal combustion engine with the help of the coupling system.

Modern internal combustion engines, in particular for motor vehicles, are equipped with a fresh air system for supplying fresh air to the internal combustion engine and with a vent mechanism for removing blow-by gases from the internal combustion engine.

During operation of an internal combustion piston engine, blow-by gases pass between the piston and the cylinder in the crankcase of the internal combustion engine because of unavoidable leakage. In order to prevent an unacceptably high pressure from developing in the crankcase, the blow-by gases are removed with the help of the vent mechanism. To prevent environmental pollution due to the pollutant-laden blow-by gases, the blow-by gases are expediently sent to the fresh air system with the help of the vent mechanism, i.e., the blow-by gases are again sent back to the internal combustion engine for combustion. To this end, a tube of the vent mechanism is connected via a socket to a line of the fresh air system.

For assembly of the internal combustion engine, said tube must be connected to the socket of the line. It should be possible to perform this connection operation with one hand and without any additional tool in order to save on assembly time. On the other hand, the tube should be removable from the socket again nondestructively, e.g., to allow repairs to be performed.

There is a known connector which has a tube connection at one end and a socket connection at the other end. The tube connection is stepped like a barb and has a circumferential ring groove in which a ring gasket is arranged. An end section of the tube can be attached to this tube connection to connect it fixedly and permanently to the connector. To this end, the end section of the tube is “jammed” onto the tube connection, i.e., the tube is heated at least in its end section and then is pushed onto the tube connection, during which the end section can be widened elastically to some extent due to the elevated temperature. In the subsequent cooling, the end section shrinks and hardens, thus more or less implementing a form-fitting connection over the steps of the tube connection. The connection between the tube and the connector has a high pull-out strength and is not intended for detachable removal of the tube from the connector.

In contrast with that, the socket connection of the connector is provided with a detachable catch engagement, which engages with the socket automatically when the socket connection is attached to the socket. To release this plug connection, the lock engagement is released in a suitable manner, so that the socket connection can be pulled away from the socket in a nondestructive manner. Sealing rings are provided in the socket connection, cooperating in the installed state with the socket inserted into the connection.

With the help of the known connector, the tube of the vent mechanism can easily be connected via the socket to the line of the fresh air system. Disconnecting is simple and can be performed easily and without destruction. However, it is a disadvantage that such a connector is relatively expensive. In addition, this connector requires a comparatively large axial installation space on the socket.

The present invention is concerned with the problem of providing an advantageous possibility for connecting the tube of the vent mechanism to the socket, which is characterized in particular by a relatively small axial installation space.

This problem is solved according to this invention by the subject matters of the independent claims. Advantageous embodiments are the subject matter of the dependent claims.

The invention is based on the general idea of implementing the desired connection with the help of a coupling system with which a connection designed on a tube can be inserted into the socket and secured on the socket with the help of a coupling element. The coupling element is a part that is manufactured separately with respect to the socket and the connection and is in turn secured axially on the connection with the help of at least one fastening hook and on the other hand can be engaged on the socket with the help of at least one catch hook. Since the connection engages in the socket, the seal between the socket and the connection occurs on the inside of the socket while the catch engagement between the coupling element and the socket takes place on the outside of the socket. In this way the sealing and the engagement can be implemented in the same axial area of the socket, so that the inventive coupling system is implemented on the socket in less axial space.

According to an advantageous embodiment, the respective connection may be manufactured in one piece with the tube. This yields an inexpensive method of manufacturing the coupling system. In particular, the tube may be designed together with the respective connection as a blow-molded part, In this way, the connection can be integrated into the manufacturing of the tube in an especially simple and inexpensive manner, so that an intersection is eliminated and the possibility of leakage is avoided.

Additional important features and advantages of the invention are derived from the subclaims, the drawings and the respective description of the figures on the basis of the drawings.

It is self-evident that the features mentioned above and those yet to be explained below may be used not only in the particular combination given but also in other combinations or alone without going beyond the scope of the present invention.

Preferred exemplary embodiments of the invention are illustrated in the drawings and explained in greater detail in the following description, where the same reference numerals refer to the same or similar or functionally identical components.

In which, schematically in each case:

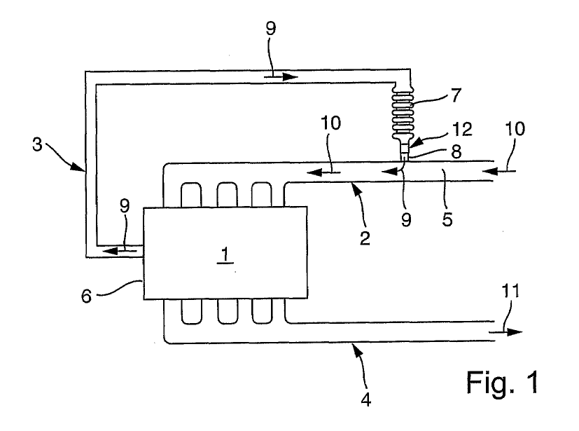

FIG. 1 shows a greatly simplified basic diagram like a wiring diagram of an internal combustion engine according to the present invention,

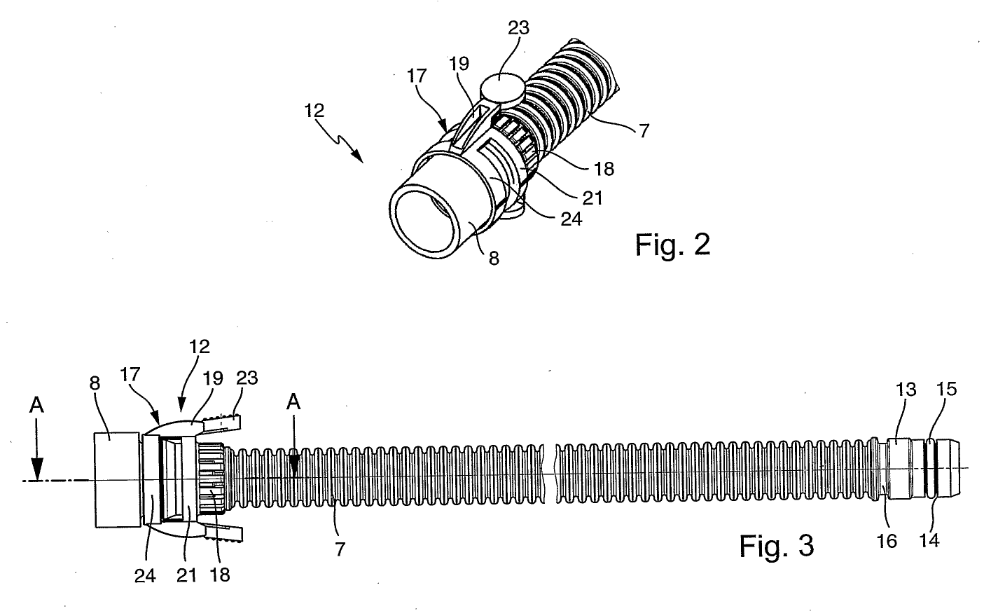

FIG. 2 shows a perspective view of a coupling system according to this invention,

FIG. 3 shows a side view of a tube with the coupling system,

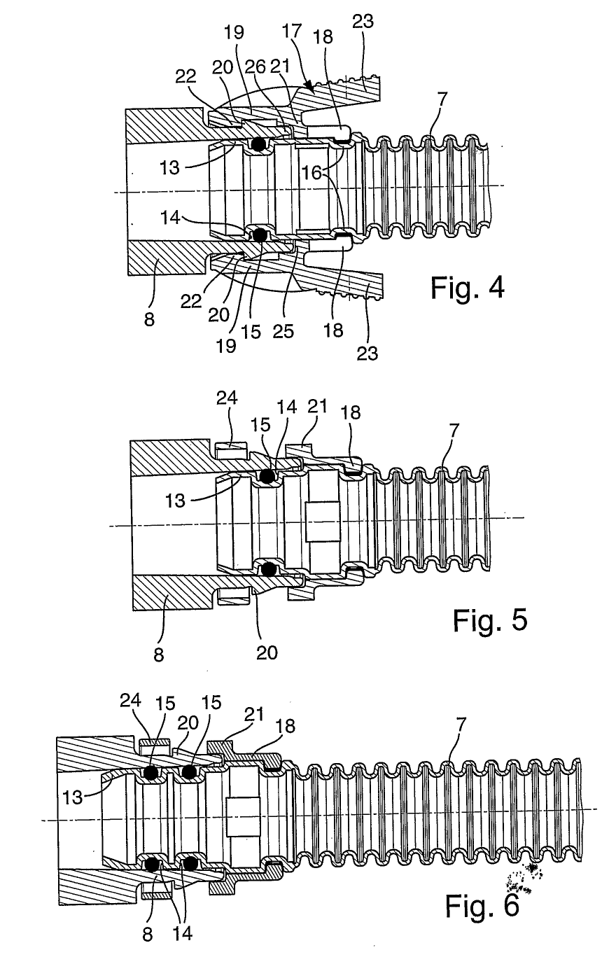

FIG. 4 shows a longitudinal section through the coupling system,

FIG. 5 shows a sectional view like that in FIG. 4, but in a different sectional plane,

FIG. 6 shows a sectional view like that in FIG. 5 but of a different embodiment.

According to FIG. 1 an inventive internal combustion engine 1, in particular for a motor vehicle, is equipped with a fresh air system 2, a vent mechanism 3 and expediently an exhaust gas system 4. The fresh air system 2 serves to supply fresh air to the internal combustion engine 1 and comprises at least one line 5. The fresh air system 2 may contain additional components (not shown here) such as a fresh air filter in the usual manner.

The vent mechanism 3 is used to remove blow-by gases from the internal combustion engine 1. The vent mechanism 3 is connected at one end to an engine block 6 of the internal combustion engine 1, communicating there with a crankcase. At the other end the vent mechanism 3 has a tube 7 which is connected via a socket 8 to the line 5. The blow-by gases 9, represented by arrows, can also be supplied in this way to the fresh air 10, likewise represented by arrows, The vent mechanism 3 may have additional components (not shown here) such as a mist collector in the usual manner.

The exhaust system 4 serves to carry away combustion gases 11 from the internal combustion engine 1 (indicated by an arrow) . The exhaust gas system 4 may also include other components (not shown here) such as a muffler, a catalytic converter, particulate filter.

According to this invention the tube 7 is connected to the socket 8 with the help of a coupling system 12. This coupling system 12 is explained in greater detail below with reference to FIGS. 2 through 6.

Although the socket 8 is formed on the line 5, in another embodiment in the example explained here, the socket 8 may also be formed on another component, e.g., on an oil mist collector device or on the crankcase and/or on the engine block 6 of the internal combustion engine 1.

According to FIGS. 2 through 6, the coupling system 12 comprises a connection 13 which can be inserted into the socket 8 and is arranged or formed on one end of the tube 7 or forms the end of the tube 7. The connection 13 has at least one ring groove 14 on its outside, serving to receive a sealing element 15. In addition, the connection 13 is equipped with a securing contour 16 on its outside.

The inventive coupling system 12 also comprises a coupling element 17 which forms a separate component with respect to the connection 13 and the tube 7 and also with respect to the socket 8. The coupling element 17 is attached to the connection 13. To do so, the coupling element 17 has at least one fastening hook 18, which cooperates with the securing contour 16. Accordingly the coupling element 17 is attached radially on the outside to the connection 13. In addition the coupling element 17 is furnished with at least one catch hook 19 with the help of which the coupling element 17 can be secured on the socket 8. To do so, the respective catch hook 19 cooperates with a catch contour 20 which is formed on the outside of the socket 8. The coupling element 17 in the inserted state of the connection 13 is attached to the socket 3 on the outside radially.

The coupling element 17 preferably has two such catch hooks 19, which are arranged to be diametrically opposed to one another. Essentially an embodiment having more than two catch hooks 19 is also possible. The individual catch hooks 19 extend parallel to the longitudinal direction of the connection 13 and proceed from a base ring 21 of the coupling element 17. On their free end at a distance from the base ring 21, the catch hooks 19 are equipped with catch noses 22, which engage axially behind the catch contour 20 in the inserted state. The catch contour 20 is preferably designed here as a ring step which has a ramp-like profile, On insertion of the connection 13, the ramp shape of the catch contour 20 causes a radial displacement of the catch hook 19. Since the catch hooks 19 are designed so they are radially stiff, the radial widening of the catch hooks 19 in the area of the catch noses 22 is accomplished by means of a spring-elastic flexural deformation in the area of the base ring 21. After exceeding the catch contour 20, the catch hooks 19 spring back inward radially, causing the catch noses 22 to engage behind the catch contour 20.

The catch contour 20 is preferably designed as a ring step, as is the case here. An embodiment of the catch contour 20 as a ring groove is also fundamentally conceivable. The ring-shaped catch contour 20 allows relative rotation between the coupling element 17 and the socket 8 while also facilitating the establishment of the connection between the tube 7 and the socket 8 and optionally also the release of this connection. Fundamentally, however, other embodiments in which the catch contour 20 is made of one or more segments bordered on the circumference, for example, are also possible. At the same time, an axial guide may be provided between the coupling element 17 and the socket 8 so that the coupling element 17 can be attached only in an intended relative rotational position between the coupling element 17 and the socket 8.

In the preferred embodiment shown here, each catch hook 19 is provided with a releasing lever 23. The respective catch hook 19 can be disengaged from the catch contour 20 by actuation of the release lever 23. The release levers 23 are designed here so that they form an extension of the respective catch hook 19, which is directed away from the socket 3. The respective release lever 23 stands freely away from the base ring 21, so that the respective release lever 23 can be forced radially inward, manually in particular, in an area at a distance from the base ring 21. Since the release levers 23 are also designed to be relatively stiff, this actuation and pivoting movement of the release levers 23 again leads to a flexible deformation in the area of the base ring 21. The area of the base ring 21 acts as a rotational bearing for the catch hooks 19, which are lengthened by the release levers 23. Accordingly, the actuation of a release lever 23 leads to a pivoting adjustment of the respective catch hook 19 directed away from the socket 8. Due to the two diametrically opposed catch hooks 19 and thus the two diametrically opposed release levers 23, the inventive coupling system can be operated with two fingers for disengaging it and removing it from the socket 8. It is especially advantageous here that the manually operated ends of the release levers 23 are removed a relatively great distance away from the catch noses 22 because this improves the manual accessibility of the coupling system 12 for releasing the connection between the socket a and the tube 7.

In the embodiments shown here, the coupling element 17 is also furnished with a ring band 24 which connects the catch hooks 19 to one another in an end area facing away from the tube 7. The catch effect of the catch hooks 19 can be reinforced by this ring band 24. The ring band 24 has a radial play, at least across the catch hooks 19 (cf. FIGS. 5 and 6) to impart to the catch hooks 19 the mobility required for disengagement. For example, the ring band 24 may have an oval cross section, while the socket 8 has a circular cross section.

The ring groove 14 for holding the sealing element 15, e.g., an O-ring, is preferably arranged in an axial section of the connection 13, which is approximately at the level of the catch contour 20 in the inserted state. In this way, the available space is utilized especially skillfully because the seal is provided by the sealing element 15 on the inside radially of the socket 8, whereas the catch engagement with the coupling element 17 and thus the connection between the socket 8 and the tube 7 are implemented on the outside of the socket 8 via the catch contour 20. The socket 8 may therefore be designed to be extremely short in the axial direction. A short axial length is also achieved on the tube end by the fact that, at least in the embodiments according to FIGS. 4 and 5, the catch hooks 19 and the connection 13 end so they are essentially flush axially on a side facing away from the tube 7.

To attach the coupling element 17 to the connection 13 in the most secure possible manner, a plurality of fastening hooks 18 that each cooperate in a form-fitting manner with the securing contour 16 may expediently be provided. The fastening hooks 18 are arranged so they are distributed in the circumferential direction. In the present case, the securing contour 16 is designed in the manner of a ring groove with claw-like protrusions of the fastening hooks 18 engaging therein in a form-fitting manner. In this way, the coupling element 17 is secured axially on the connection 13. Preferably, however, the coupling element 17 may also be mounted on the connection 13, so it can rotate about the longitudinal axis of the connection 13. Essentially a free unlimited rotatability between the coupling element 17 and the connection 13 is possible. Likewise, through appropriate stops, rotatability for only a predetermined angular range between the coupling element 17 and the connection 13 may be implemented. Rotatability between the coupling element 17 and the connection 13 simplifies assembly because the coupling element 17 can therefore be aligned optimally and an especially simple manner.

The base ring 21 on the coupling element 17 is constructed with a stepped design. On an area of the base ring 21 that is on the inside radially, the fastening hooks 18 protrude axially in the direction of the tube 7. In contrast with that, the catch hooks 19 are arranged on an area of the base ring 21 that is on the outside radially, whereby the catch hooks 19 protrude away from the base ring 21 in a direction away from the tube 7. Due to its stepped profile, the base ring 21 together with the outside of the connection 13 forms a ring receptacle 24 which is open axially, namely toward the socket 8. In the attached state, an axial end 25 of the socket 8 engages in this ring receptacle 24. In this way, the base ring 21 extends at least partially beyond the socket 8 in the axial direction, so that an especially stable connection between the tube 7 and the socket 8 can be achieved.

The coupling element 17 is preferably manufactured in one piece, i.e., the base ring 21, the catch hooks 19, their release levers 23 and the fastening hooks 18 together may form an integral component that is manufactured by the injection molding process, for example.

Tube 7 is preferably a corrugated tube. Essentially, however, other types of tubes are also possible. Corrugated tubes are characterized by a high compressive stability and a comparatively high flexibility with respect to bending. The connection 13 is preferably manufactured in one piece together with the tube 7. The connection 13 is therefore integrated into the tube 7 and/or into the manufacturing process of the tube 7, which offers cost advantages. The tube 7 can preferably be manufactured as a blow-molded part together with the connection 13 formed on it. Blow-molded parts are characterized by relatively narrow manufacturing tolerances with respect to their outside contours. Since the outside contours are particularly important in the case both the tube 7 and the connection 13, this results in quality advantages. Narrow tolerances with regard to the dimensions of the outside contour of the connection 13 also simplify the implementation of a sufficient seal with the help of the sealing element 15. At the same time, this also simplifies assembly and disconnection. The greater the tolerances in the dimensions, the greater the play the sealing element 15 must be able to equalize.

With the embodiments shown here, the connection 13 is designed as a straight pipe section which develops into the tube 7 in a straight line. For certain applications or installation situations, however, it may be expedient to design the connection 13 as a curved section or as an angled section. In such an embodiment, a corresponding curve section or angled section which forms the transition between the straight section and the tube 7 is then connected to the straight section of the connection 13 shown here. Curved sections and angled sections are expedient in particular when bending radii or angles that cannot be achieved with the tube 7 are to be implemented.

With the embodiments shown here, the tube 7 as well as the connection 13 and the socket 8 each have a circular cross section, Essentially, however, other embodiments are also conceivable, e.g., with an oval cross section or with a polygonal cross section such as a hexagonal cross section, an octagonal cross section or a rectangular cross section.

The connection 13 and the tube 7 are expediently coordinated with one another with regard to their flow cross sections, so that said flow cross sections are approximately of the same size. For example, the flow cross sections deviate from one another by less than 15% or less than 10%. In this way, greater changes in cross section can be avoided in the connection between the tube 7 and the socket 8 to prevent an unwanted drop in pressure in the tube 7.

According to FIG. 3, the tube 7 may essentially be provided with a connection 13 on both of its ends to implement the coupling system 12 according to this invention.

Whereas the connection 13 has only one ring groove 14 in the embodiments of FIGS. 4 and 5, a second ring groove 14 is provided in the embodiment according to FIG. 6, with another sealing element 15 arranged in the groove. In addition to an improved imperviousness, this embodiment also leads to an increased stability of the connection between the tube 7 and the socket 8.

Manufacturing of the inventive coupling system 12 is comparatively inexpensive. First, the respective connection 13 may be designed as an integral part of the tube 7. Secondly, the coupling element 17 can be manufactured in one piece. Furthermore, the coupling element 17 can be attached to the connection 13 in an automated operation relatively easily. In addition, the operation of inserting the sealing element 15 into the ring groove 14 can also be automated easily. Establishing the connection between the tube 7 and the socket 8 is also simplified because the coupling system 12 implements a plug connection that allows automatic engagement. Disconnecting is also relatively simple because the release levers 23 allow easy disengagement of the catch hooks 19. Furthermore, the accessibility of the release levers 23 which extend away from the socket 8 is improved. The rotatability of the coupling element 17 in relation to the connection 13 also facilitates the establishment and optionally the release of the connection between the tube 7 and the socket 8. However, it is especially important that the inventive coupling system 12 is designed to be relatively small in the axial direction so that in particular the socket 8 can be designed to be relatively short axially. This is advantageous in view of the tight spatial situation prevailing in the engine space of a motor vehicle.

1. A coupling system for connecting a tube of a vent mechanism for removing blow-by gases from an internal combustion engine, comprising:
a socket, including a catch contour on its outside;
a connection on at least one end of the tube that can be inserted into the socket including at least one ring groove on its outside and a securing contour:
a coupling element removably attached over the connection including at least one catch hook configured to engages behind the catch contour when the connection is inserted into the socket and at least one fastening hook that cooperates with the securing contour on the connection for axial fixation of the coupling element.

2. The coupling system according to claim 1, wherein at least one of:
the connection is manufactured in one piece together with the tube,
the tube is designed as a blow-molded part together with the respective connection,
the tube is designed as a corrugated tube,
the connection is designed as one of a straight pipe section, a curved section, and an angled section,
a flow cross section of the tube and a flow cross section of the connection deviate from one another by one of less than 15%, less than 10%, and 0%,
by one of less than 15%, less than 10%, and 0%
the connection has at least two ring grooves on its outside to receive a sealing element in each,
the sealing element is an O-ring, and
the tube has one of a circular, oval, and polygonal cross section.

3. The coupling system according to claim 1, wherein at least one of:
the catch hook has an operable release lever for disengaging the catch hook from the catch contour the release lever forms an extension of the respective catch hook leading away from the socket, and
the release lever protrudes freely away from a base ring of the coupling element which at least partially overlaps the socket in the connected state.

4. The coupling system according to claim 1, wherein at least one of:
the securing contour has a ring step design,
the fastening hook cooperates in a form-fitting manner with the securing contour,
a plurality of fastening hooks is provided and arranged circumferentially about the coupling element and cooperate with the securing contour for axial fixation of the coupling element on the connection, and
the coupling element is arranged on the connection so that it can rotate freely in a predetermined angular range.

5. The coupling system according to claim 1, wherein at least one of:
the at least one catch hook includes at least two catch hooks in an equally spaced arrangement,
the coupling element is arranged on the connection such that respective ends of the catch hook and the connection are axially flush,
the catch hook has a has a catch nose which cooperates with the catch contour in the connected state,
the catch contour is formed by one of a ring step and a ring groove,
the catch hooks are connected to one another by a ring band on an end area facing away from the tube,
the socket is disposed on one of the internal combustion engine, the vent mechanism, and a fresh air system of the internal combustion engine.

6. The coupling system according to claim 1, wherein at least one of:
the coupling element is manufactured as one piece,
the coupling element has a base ring from which emanates the at least one catch hook on one end and the at least one fastening hook on the other end, and
a base ring of the coupling element together with the outside of the connections forms an axially open ring receptacle in which an axial end of the socket engages in the connected state.

7. (canceled)

8. (canceled)

9. (canceled)

10. The coupling system according to claim 1, wherein the tube has the connection, the internal combustion engine has the socket, and the connection on the tube end can be inserted into the socket on the internal combustion engine.

11. A coupling device for securing a tube connection to a socket, comprising:
at least one fastening hook configured to selectively engage a securing contour of the tube;
at least one catch hook configured to selectively engage a catch contour of the socket;
a receptacle for receiving the socket formed from the axial overlap of the at least one catch hook and the tube connection;
a base ring interconnecting the at least one fastening hook and the at least one catch hook; and
a release lever attached to the base ring for concurrently controlling the selective engagement of the at least one fastening hook and the at least one catch hook.
